(19) United States
(12) Patent Application Publication
(10) Pub. No.: US 2026/0367438 A1
(43) Pub. Date: Nov. 19, 2026

(54) ELECTRONIC DEVICE

(71) Applicant: Innolux Corporation, Miaoli County (TW)

(72) Inventors: Mei-Wen Jao, Miaoli County (TW); Chang-Chiang Cheng, Miaoli County (TW); En-Jie Chen, Miaoli County (TW); Yung-Hsun Wu, Miaoli County (TW); Yi-Hsin Lin, Hsinchu City (TW)

(73) Assignee: Innolux Corporation, Miaoli County (TW)

(21) Appl. No.: 19/646,585

(22) Filed: Apr. 14, 2026

(30) Foreign Application Priority Data
May 14, 2025 (CN) 202510620772.3

(51) Int. Cl. G02F 1/1333; G02F 1/1339

(52) U.S. Cl. CPC G02F 1/133368; G02F 1/1339

(57) ABSTRACT

An electronic device includes a first panel, a first conductive material and a second conductive material. The first panel includes a first substrate, a medium layer, a first transparent conductive layer and a second transparent conductive layer. The first substrate has a side. The medium layer is disposed on the substrate. The first transparent conductive layer is disposed between the first substrate and the medium layer. The second transparent conductive layer is disposed between the first transparent conductive layer and the medium layer, wherein the first transparent conductive layer and the second transparent conductive layer extend to the side of the first substrate. The first conductive material is disposed on the side of the first substrate, and is electrically connected to the first transparent conductive layer. The second conductive material is disposed on the side of the first substrate, and is electrically connected to the second transparent conductive layer.

### CROSS-REFERENCE TO RELATED APPLICATION

This application claims the priority benefit of China application serial no. 202510620772.3, filed on May 14, 2025. The entirety of the above-mentioned patent application is hereby incorporated by reference herein and made a part of this specification.

### BACKGROUND

### Technical Field

The disclosure relates to an electronic device.

### Description of Related Art

Electronic devices utilize outer lead bonding (OLB) for external circuit connections. In smart glasses, OLB typically features ear-shaped protrusions on the frame, which are prone to breakage during motherboard cutting, leading to low yields and increased frame dimensions.

### SUMMARY

The disclosure provides an electronic device that can have a relatively high yield.

According to some embodiments of the disclosure, an electronic device includes a first panel, a first conductive material and a second conductive material. The first panel includes a first substrate, a medium layer, a first transparent conductive layer and a second transparent conductive layer. The first substrate has a side. The medium layer is disposed on the substrate. The first transparent conductive layer is disposed between the first substrate and the medium layer. The second transparent conductive layer is disposed between the first transparent conductive layer and the medium layer, wherein the first transparent conductive layer and the second transparent conductive layer extend to the side of the first substrate. The first conductive material is disposed on the side of the first substrate, and is electrically connected to the first transparent conductive layer. The second conductive material is disposed on the side of the first substrate, and is electrically connected to the second transparent conductive layer.

### BRIEF DESCRIPTION OF THE DRAWINGS

FIGS. 1A to 1C are partial top views of an electronic device according to a first embodiment of the disclosure.

FIG. 2 is a partial cross-sectional view according to a section line A-A' of FIG. 1A.

FIG. 3 is a partial cross-sectional view of an electronic device according to a second embodiment of the disclosure.

FIG. 4 is a partial cross-sectional view of an electronic device according to a third embodiment of the disclosure.

FIG. 5 is a partial top view of an electronic device according to a fourth embodiment of the disclosure.

FIG. 6 is a partial cross-sectional view of an electronic device according to a fourth embodiment of the disclosure.

FIG. 7A is a partial top view of an electronic device according to a fifth embodiment of the disclosure.

FIG. 7B is a partial top view of an electronic device according to a sixth embodiment of the disclosure.

FIG. 7C is a partial top view of an electronic device according to a seventh embodiment of the disclosure.

FIG. 8 is a partial top view of an electronic glasses of an embodiment of the disclosure.

### DESCRIPTION OF THE EMBODIMENTS

The disclosure may be understood with reference to the following detailed description with the drawings. Note that for clarity of description and ease of understanding, the drawings of the disclosure show a part of an electronic device, and certain components in the drawings may not be drawn to scale. In addition, the number and size of each device shown in the drawings simply serve for exemplifying instead of limiting the scope of the disclosure.

Certain words will be used to refer to specific devices throughout the specification and the appended claims of the disclosure. People skilled in the art should understand that manufacturers of electronic devices may refer to same elements under different names. The disclosure does not intend to distinguish devices with the same functions but different names. In the following specification and claims, the terminologies “including”, “comprising”, “having”, etc. are open-ended terminologies, so they should be interpreted to mean “including but not limited to ...”. Therefore, when the terminologies “including”, “comprising”, and/or “having” are used in the description of the disclosure, the terminologies designate the presence of a corresponding feature, region, step, operation, and/or component but do not exclude the presence of one or more corresponding features, regions, steps, operations, and/or components.

In the accompanying drawings, each drawing shows the general features of the methods, structures and/or materials adopted in a specific embodiment. However, the drawings should not be construed as defining or limiting the scope or nature covered by the embodiments. For instance, for clarity, the relative size, thickness, and position of each layer, region, and/or structure may be reduced or enlarged.

When a corresponding element (such as a film layer or a region) is referred to as being “on another element”, the element may be directly on the other element or there may be another element between the two. On the other hand, when an element is referred to as being "directly on another element”, there is no element between the two. Also, when an element is referred to as being “on another element”, the two have a top-down relationship in the top view direction, and the element may be above or below the other element, and the top-down relationship depends on the orientation of the device.

The terminologies “same” are generally interpreted as being within 20% of a given value or range, or interpreted as being within 10%, 5%, 3%, 2%, 1%, or 0.5% of a given value or range.

The ordinal numbers used in the specification and claims, such as the terminologies “first”, “second”, and the like, to qualify a component do not imply or represent that the component or components are preceded with any ordinal numbers, nor do they represent the order of a certain component and another component, or the order in the manufacturing method, and are used to clearly distinguish a component with one name from another component with the same name. Different terminologies may be used in the claims and the specification, and accordingly, a first component in the specification may be a second component in the claims.

Note that in the following embodiments, the technical features provided in several different embodiments may be replaced, reorganized, and mixed without departing from the spirit of the disclosure so as to complete other embodiments. The technical features of the embodiments may be mixed and matched arbitrarily as long as they do not violate the spirit of the disclosure or conflict with each other.

The electrical connection or electric connection described in this disclosure may refer to either a direct connection or an indirect connection. In the case of the direct connection, terminals of elements on two circuits are directly connected or interconnected by a conductive wire segment. In the case of the indirect connection, switches, diodes, capacitors, inductors, other appropriate elements, or combinations of the above elements may exist between terminals of elements on two circuits, which should however not be construed as a limitation in the disclosure.

Additionally, certain errors between any two values or directions for comparison may be acceptable. If a first value is equal to a second value, it indicates that a margin of error of about 10% may exist between the first and second values. If a first direction is perpendicular to a second direction, an angle difference between the first direction and the second direction may be between 80 degrees and 100 degrees.

The electronic device provided in the disclosure may be applied to a vision correction device, a display device, a vehicle device, an imaging device, an assembly device, a backlight device, or a light-emitting device. The electronic device may include a foldable or flexible electronic device. The display device may be a non-self-luminous display device or a self-luminous display device. The electronic device may include a diode, a liquid crystal, a light emitting diode (LED), a quantum dot (QD), fluorescence, phosphor, other suitable display media, or a combination thereof. The LEDs may include organic light-emitting diodes (OLEDs), mini LEDs, micro LEDs, or quantum dot (QD) LEDs, which should however not be construed as a limitation in the disclosure. It should be noted that the electronic device may be any combination of the above, which should however not be construed as a limitation in the disclosure.

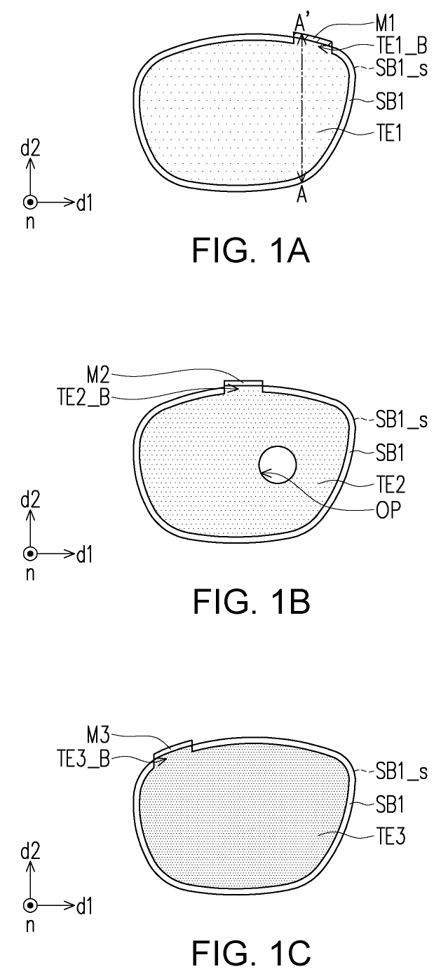

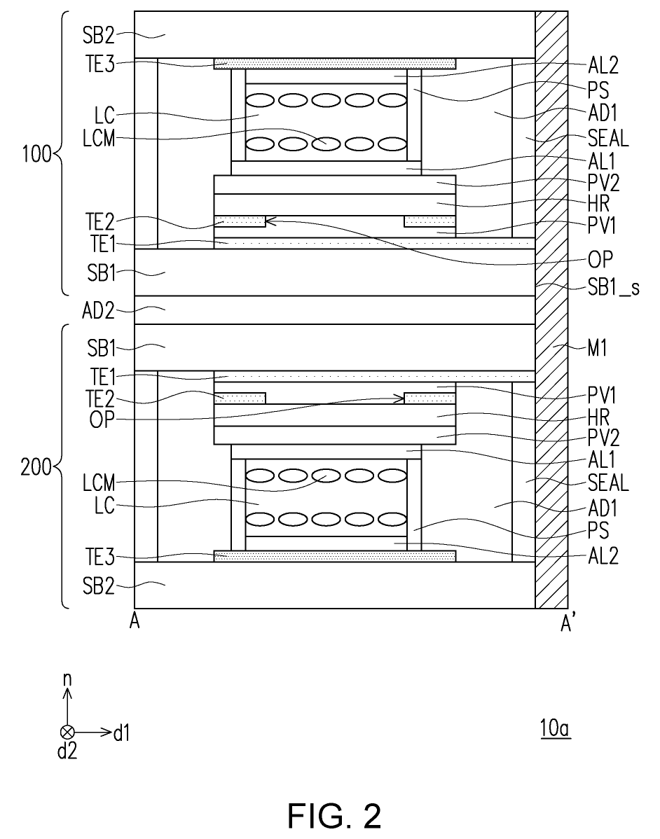

Referring to FIGS. 1A-1C and 2, in the present embodiment, an electronic device 10a includes a panel 100, a conductive material M1 and a conductive material M2. FIGS. 1A-1C respectively illustrate a transparent conductive layer TE1, a transparent conductive layer TE2 and a transparent conductive layer TE3 when observed in a top view direction (for example, observed in a normal direction n), and illustrate their respective configuration relationships with a substrate SB1. In the electronic device disclosed in the disclosure, the transparent conductive layer TE1, the transparent conductive layer TE2 and the transparent conductive layer TE3 at least partially overlap with each other. FIG. 2 shows the cross-sectional view of the transparent conductive layer TE1, the transparent conductive layer TE2 and the transparent conductive layer TE3 overlapping at a protruding TE1_B of the transparent conductive layer TE1.

The panel 100 is an optical modulation structure and has an electrically tunable-focusing property, but the disclosure is not limited thereto. In the present embodiment, the panel 100 includes a substrate SB1, a medium layer LC, the transparent conductive layer TE1 and the transparent conductive layer TE2.

The substrate SB1 is a flexible substrate or an inflexible substrate. A material of the substrate SB1 includes glass, plastic or a combination thereof. In the present embodiment, the substrate SB1 has a side SB1_s.

In some embodiments, the electronic device 10a further include a substrate SB2.

The substrate SB2 is opposite to the substrate SB1 in the normal direction n of the electronic device 10a. In some embodiments, a material of the substrate SB2 is the same as or similar to the material of the substrate SB1 and will be omitted herein.

The medium layer LC is disposed on the substrate SB1. In some embodiments, the medium layer LC includes liquid crystal molecules LCM. The liquid crystal molecules LCM can be arranged by a change in the voltage. For example, when the electronic device 10a is not driven, the liquid crystal molecules LCM are arranged according to alignment directions (for example, a first direction d1) of an alignment layer AL1 and an alignment layer AL2 to be described later. In contrast, when the electronic device 10a is driven, the liquid crystal molecules LCM have a corresponding tilt direction according to the voltage between two electrodes. In some embodiments, the medium layer LC includes electrically controlled birefringence (ECB) liquid crystal molecules, vertical alignment (VA) liquid crystal molecules, or other suitable liquid crystal molecules, but the disclosure is not limited thereto.

The transparent conductive layer TE1 is disposed between the substrate SB1 and the medium layer LC. In some embodiments, the transparent conductive layer TE1 is entirely disposed on the substrate SB1. In some embodiments, a material of the transparent conductive layer TE1 includes metal oxide (for example, indium tin oxide), carbon nanotubes, graphene, other suitable materials or combinations thereof, but the disclosure is not limited thereto.

The transparent conductive layer TE2 is disposed between the transparent conductive layer TE1 and the medium layer LC, and has an opening OP. In other words, the transparent conductive layer TE2 is a patterned transparent conductive layer. For example, the transparent conductive layer TE2 has a ring structure and has the opening OP, but the disclosure is not limited thereto. In the present embodiment, the electronic device 10a has an optical modulation region and a non-optical modulation region, wherein the optical modulation region overlaps with the opening OP of the transparent conductive layer TE2 in the normal direction n of the electronic device 10a, and the non-optical modulation region of the electronic device 10a at least partially overlaps with the transparent conductive layer TE1 and the transparent conductive layer TE2 in the normal direction n of the electronic device 10a. Namely, the optical modulation region and the non-optical modulation region of the electronic device 10a are defined by the transparent conductive layer TE1 and the transparent conductive layer TE2. The non-optical modulation region of the electronic device 10a has a fixed focal length (or diopter), and the optical modulation region of the electronic device 10a can adjust its focal length (or diopter) by changing the voltage.

In some embodiments, a material of the transparent conductive layer TE2 is the same as or similar to the material of the transparent conductive layer TE1 and will be omitted herein.

In the present embodiment, the transparent conductive layer TE1 and the transparent conductive layer TE2 extend to the side SB1_s of the substrate SB1. In detail, the transparent conductive layer TE1 and the transparent conductive layer TE2 respectively have the protrusion TE1_B and a protrusion TE2_B, wherein the protrusion TE1_B and the protrusion TE2_B extend to the side SB1_s of the substrate SB1 and are aligned with the side SB1_s of the substrate SB1, but the disclosure is not limited thereto.

In some embodiments, the electronic device 10a further includes a transparent conductive layer TE3.

The transparent conductive layer TE3 is disposed between the substrate SB2 and the medium layer LC. In some embodiments, a material of the transparent conductive layer TE3 is the same as or similar to the material of the transparent conductive layer TE1 and would be omitted herein. In the present embodiment, the transparent conductive layer TE3 also extends to the side SB1_s of the substrate SB1. In detail, the transparent conductive layer TE3 has a protrusion TE3_B, wherein the protrusion TE3_B extends to the side SB1_s of the substrate SB1, and is aligned with the side SB1_s of the substrate SB1, but the disclosure is not limited thereto.

Continuing to refer to FIGS. 1A-1C and 2 , the conductive material M1 is disposed on the side SB1_s of the substrate SB1 and is electrically connected to the transparent conductive layer TE1. In detail, the conductive material M1 contacts the side SB1_s of the substrate SB1, so as to contact the transparent conductive layer TE1 extending to the side SB1_s of the substrate SB1 to be electrically connected to each other. In the present embodiment, the conductive material M1 includes silver paste, but the disclosure is not limited thereto. In other embodiments, the conductive material M1 includes other conductive materials. For example, the conductive material M1 includes a conductive material formed by performing an electroplating process.

The conductive material M2 is disposed on the side SB1_s of the substrate SB1 and is electrically connected to the transparent conductive layer TE2. In detail, the conductive material M2 contacts the side SB1_s of the substrate SB1, so as to contact the transparent conductive layer TE2 extending to the side SB1_s of the substrate SB1 to be electrically connected to each other. In some embodiments, a material of the conductive material M2 is the same as or similar to the material of the conductive material M1 and would be omitted herein.

In some embodiments, the electronic device 10a further includes a conductive material M3.

The conductive material M3 is disposed on the side edge SB1_s of the substrate SB1 and is electrically connected to the transparent conductive layer TE3. In detail, the conductive material M3 contacts the side SB1_s of the substrate SB1, so as to contact the transparent conductive layer TE3 extending to the side SB1_s of the substrate SB1 to be electrically connected to each other. In some embodiments, a material of the conductive material M3 is the same as or similar to the material of the conductive material M1, and would be omitted herein.

In the present embodiment, the protrusion TE1_B of the transparent conductive layer TE1, the protrusion TE2_B of the transparent conductive layer TE2 and the protrusion TE3_B of the transparent conductive layer TE3 respectively extend to the side SB1_s of the substrate SB1, and the conductive material M1, the conductive material M2 and the conductive material M3 can be electrically connected to the protrusion TE1_B, the protrusion TE2_B and the protrusion TE3_B respectively. Therefore, a circuit module (not shown) can be electrically connected to the electronic device 10a through the above protrusions and the above conductive materials to provide power to the electronic device 10a and/or to drive the electronic device 10a. Based on the above, an area of the outer lead bonding (OLB) of the present embodiment can be reduced, so a size of the electronic device 10a can be reduced and a yield of the electronic device 10a can be improved.

In addition, in the present embodiment, the protrusion TE1_B of the transparent conductive layer TE1, the protrusion TE2_B of the transparent conductive layer TE2, and the protrusion TE3_B of the transparent conductive layer TE3 do not overlap with each other in the normal direction n of the electronic device 10a. The design can reduce the possibility of interference between a plurality of signals transmitted to the electronic device 10a through the above protrusions.

In some embodiments, the electronic device 10a further includes an insulating layer PV1, a high resistance film HR, an insulating layer PV2, an alignment layer AL1 and an alignment layer AL2 disposed between the substrate SB1 and the substrate SB2.

The insulating layer PV1 is disposed between the transparent conductive layer TE1 and the transparent conductive layer TE2. In some embodiments, the insulating layer PV1 is used to electrically isolate the transparent conductive layer TE1 and the transparent conductive layer TE2 from each other. A material of the insulating layer PV1 includes an inorganic material (for example, silicon oxide, silicon nitride, silicon oxynitride, or a stacked layer of at least two of the above materials), an organic material (for example, polyimide resin, epoxy resin, or acrylic resin), or a combination thereof, but the disclosure is not limited thereto.

The high resistance film HR is disposed on the insulating layer PV1. In the present embodiment, the high resistance film HR is completely disposed on the transparent conductive layer TE2, but the disclosure is not limited thereto. The high resistance film HR has a relatively high surface impedance, which helps to slow down the electric field change in a direction perpendicular to the normal direction n of the electronic device 10a (for example, the first direction d1 or a second direction d2) when driving the electronic device 10a, so that the electronic device 10a can form a relatively good image quality. A material of the high resistance film HR includes conductive polymer, transparent conductive oxide, metal, carbon nanotube, graphene or a combination thereof, but the disclosure is not limited thereto.

The insulating layer PV2 is disposed on the high resistance film HR. In some embodiments, a material of the insulating layer PV2 is the same as or similar to the material of the insulating layer PV1 and would be omitted herein.

The alignment layer AL1 is disposed on the insulating layer PV2. The alignment layer AL1 is used to align the medium layer LC of the electronic device 10a in a horizontal direction or a vertical direction and/or provide a pre-tilt angle for the medium layer LC. A material included in the alignment layer AL1 is polyimide, but the disclosure is not limited thereto.

The alignment layer AL2 is disposed on the transparent conductive layer TE3. The alignment layer AL2 is also be used to align the medium layer LC of the electronic device 10a in the horizontal direction or the vertical direction and/or provide a pre-tilt angle to the medium layer LC. In some embodiments, a material of the alignment layer AL2 is the same as or similar to the material of the alignment layer AL1 and would be omitted herein.

The sealant SEAL is disposed between the substrate SB1 and the substrate SB2 and is located around the medium layer LC. In some embodiments, the sealant SEAL is used to bond the substrate SB1 and the substrate SB2 and form a space for accommodating the medium layer LC with the substrate SB1 or the substrate SB2.

In the present embodiment, the transparent conductive layer TE1, the transparent conductive layer TE2 and the transparent conductive layer TE3 extending to the side SB1_s of the substrate SB1 are not provided with the sealant SEAL. Namely, outer sides of the transparent conductive layer TE1, the transparent conductive layer TE2 and the transparent conductive layer TE3 may be flush with outer sides of the sealant SEAL of other parts. In the present embodiment, outer sides of the transparent conductive layer TE1, the transparent conductive layer TE2, the transparent conductive layer TE3 and a portion of the sealant SEAL are aligned with the side SB1_s of the substrate SB1, but the disclosure is not limited thereto.

In some embodiments, the electronic device 10a further includes an adhesive layer AD1 and a support member PS.

The adhesive layer AD1 is disposed between the substrate SB1 and the substrate SB2 and is located between the sealant SEAL and the medium layer LC. In some embodiments, the adhesive layer AD1 is also used to bond the substrate SB1 and the substrate SB2, so that the substrate SB1 and the substrate SB2 can be bonded more evenly. A material of the adhesive layer AD1 includes optical clear adhesive (OCA), optical clear resin (OCR) or liquid optically clear adhesive (LOCA), but the disclosure is not limited thereto.

The support member PS is disposed between the substrate SB1 and the substrate SB2 and is located between the adhesive layer AD1 and the medium layer LC. In some embodiments, the support member PS is used to support the substrate SB1 and the substrate SB2. A material of the support member PS is a suitable organic material or an inorganic material, but the disclosure is not limited thereto.

In some embodiments, the electronic device 10a may further include a panel 200, wherein the panel 200 is stacked with the panel 100.

Specifically, in the present embodiment, the electronic device 10a includes the panel 100, a panel 200, and an adhesive layer AD2, wherein the panel 100 is adhered to the panel 200 via the adhesive layer AD2. A material of the adhesive layer AD2 may be the same as or similar to the material of the adhesive layer AD1 and would be omitted herein.

It is worth noting that components included in the panel 200 may be the same as or similar to the above components included in the panel 100, and would be omitted herein.

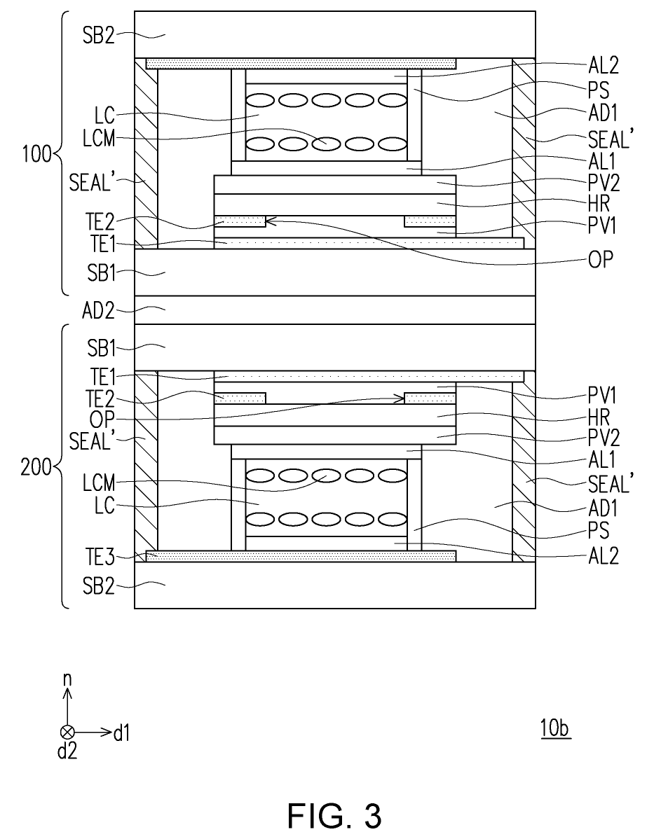

It should be noted that the embodiment of FIG. 3 may use the reference numbers and some contents of the embodiment of FIG. 2, wherein the same or similar reference numbers are used to represent the same or similar components, and the description of the same technical contents is omitted.

In the present embodiment, the main difference between the electronic device 10b and the electronic device 10a is that the electronic device 10b includes a sealant SEAL’, wherein the sealant SEAL’ includes a conductive material, and the transparent conductive layer TE1, the transparent conductive layer TE2 and the transparent conductive layer TE3 extend to the sealant SEAL’.

The sealant SEAL’ is used to replace the conductive material M1, the conductive material M2, and the conductive material M3 recited in the above embodiments. In detail, in the present embodiment, the transparent conductive layer TE1, the transparent conductive layer TE2 and the transparent conductive layer TE3 are in contact with the sealant SEAL’. Therefore, the transparent conductive layer TE1, the transparent conductive layer TE2 and the transparent conductive layer TE3 are electrically connected to a circuit module (not shown) through the sealant SEAL’. It is worth noting that the sealant SEAL (not shown in FIG. 3) not in contact with the transparent conductive layer TE1, the transparent conductive layer TE2, and the transparent conductive layer TE3 includes a non-conductive material.

In the present embodiment, the sealant SEAL’ is disposed on the side SB1_s of the substrate SB1 and is electrically connected to the transparent conductive layer TE1. In detail, the outer side of the sealant SEAL is aligned with the side SB1_s of the substrate SB1 to be electrically connected to the transparent conductive layer TE1, but the disclosure is not limited thereto.

In the present embodiment, the outer sides of the transparent conductive layer TE1, the transparent conductive layer TE2, and the transparent conductive layer TE3 may be flush with outer sides of a portion of the sealant SEAL. In other words, the outer sides of the transparent conductive layer TE1, the transparent conductive layer TE2, the transparent conductive layer TE3 and the portion of the sealant SEAL are aligned with the side SB1_s of the substrate SB1, but the disclosure is not limited thereto.

In the present embodiment, the main difference between the electronic device 10c and the electronic device 10b is that the substrate SB2 includes a through hole T.

In the present embodiment, the substrate SB2 includes a through hole T1, a through hole T2 and a through hole T3, and the transparent conductive layer TE1, the transparent conductive layer TE2 and the transparent conductive layer TE3 are electrically connected to the conductive material M1, the conductive material M2 and the conductive material M3 respectively through the through hole T1, the through hole T2 and the through hole T3. In some embodiments, the through hole T1, the through hole T2, and the through hole T3 of the substrate SB2 are filled with transparent conductive materials, respectively.

Based on the above, the electronic device 10c has the increased conductive area without affecting the visual effect, so as to enhance the signal transmission effect.

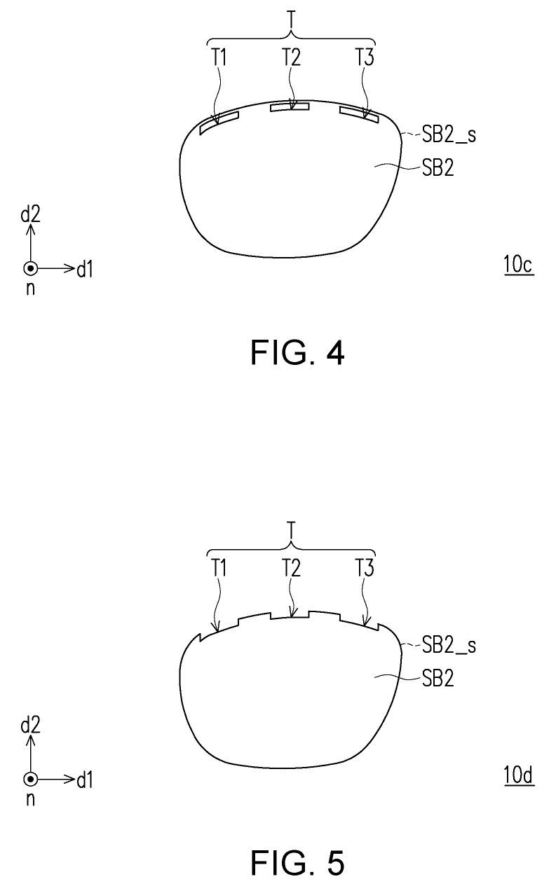

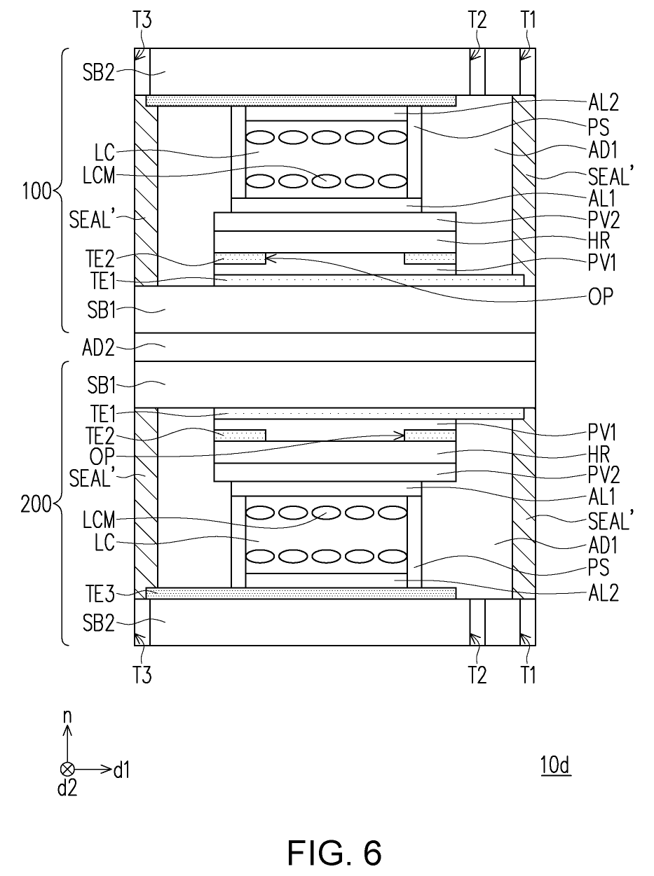

FIG. 5 is a partial top view of an electronic device according to a fourth embodiment of the disclosure, and FIG. 6 is a partial cross-sectional view of an electronic device according to a fourth embodiment of the disclosure. It should be noted that the embodiment of FIGS. 5 and 6 may use the reference numbers and some contents of the embodiment of FIG. 4, wherein the same or similar reference numbers are used to represent the same or similar components, and the description of the same technical contents is omitted.

In the present embodiment, the main difference between the electronic device 10d and the electronic device 10c is that the through hole T of the substrate SB2 extends to the side SB2_s of the substrate SB2.

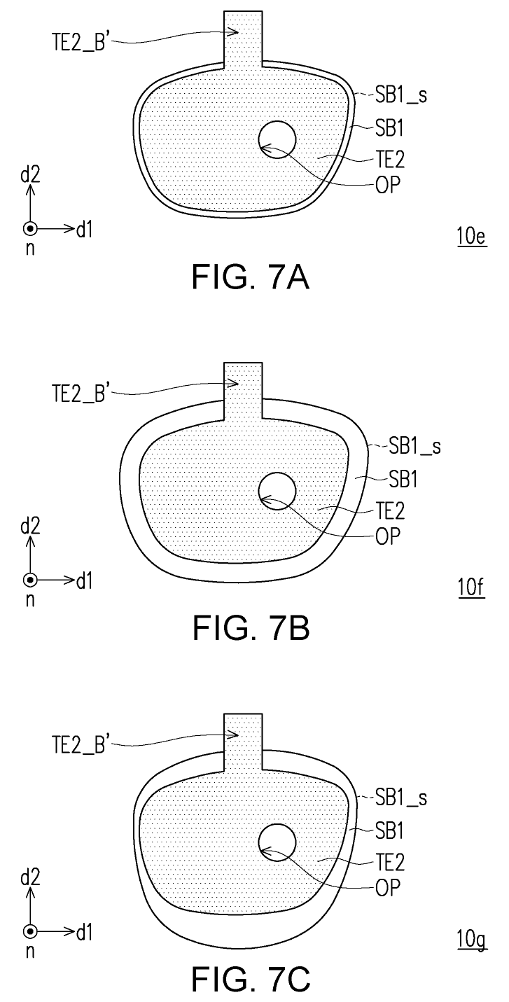

FIG. 7A is a partial top view of an electronic device according to a fifth embodiment of the disclosure. It should be noted that the embodiment of FIG. 7A may use the reference numbers and some contents of the embodiment of FIGS. 1B and 2, wherein the same or similar reference numbers are used to represent the same or similar components, and the description of the same technical contents is omitted.

In the present embodiment, the main difference between the electronic device 10e and the electronic device 10a is that the protrusion TE2_B’ of the transparent conductive layer TE2 extends beyond the side SB1_s of the substrate SB1.

Based on the above, when a mother board (not shown) is cut to form the panel 100, the number of masks used in the cutting process can be reduced. For example, the mask may be repeatedly used to form the panel 100 with a relatively large size and/or the panel 100 with an irregular shape, and the protrusion TE2_B’ of the transparent conductive layer TE2 with a relatively large size may be more suitable for the panel 100 with the above situation.

FIG. 7B is a partial top view of an electronic device according to a sixth embodiment of the disclosure. It should be noted that the embodiment of FIG. 7B may use the reference numbers and some contents of the embodiment of FIG. 7A, wherein the same or similar reference numbers are used to represent the same or similar components, and the description of the same technical contents is omitted.

In the present embodiment, the main difference between the electronic device 10f and the electronic device 10e is that the size of the substrate SB1 in the first direction d1 and the second direction d2 is increased, so that a profile of the side SB1_s of the substrate SB1 in the normal direction n of the electronic device 10f is enlarged.

FIG. 7C is a partial top view of an electronic device according to a seventh embodiment of the disclosure. It should be noted that the embodiment of FIG. 7C may use the reference numbers and some contents of the embodiment of FIG. 7B, wherein the same or similar reference numbers are used to represent the same or similar components, and the description of the same technical contents is omitted.

In the present embodiment, the main difference between the electronic device 10g and the electronic device 10f is that the proportion of the increase in the size of the substrate SB1 in the first direction d1 is greater than the proportion of the increase in the size of the substrate SB1 in the second direction d2. The electronic device 10g may have a different profile increase from the electronic device 10f.

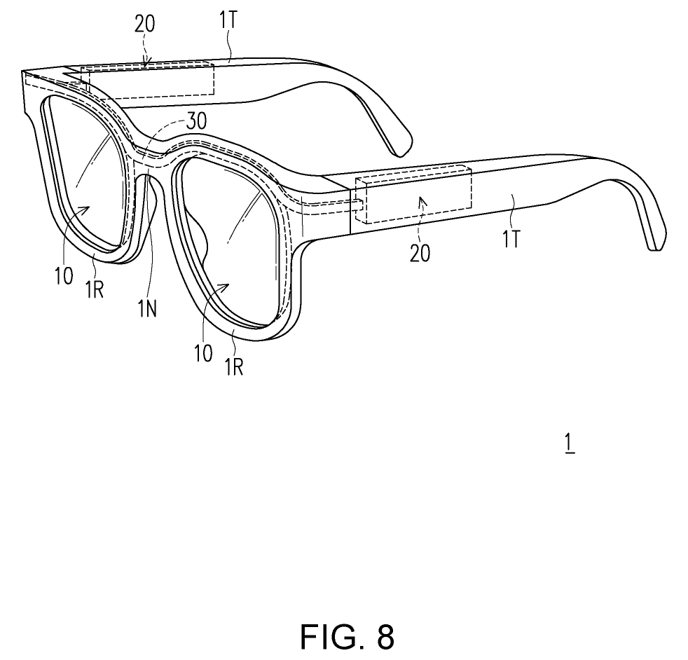

FIG. 8 is a partial top view of the electronic glasses according to the first embodiment of the present disclosure. It should be noted that the embodiment of FIG. 8 may use the component numbers and some contents of the embodiment of FIG. 2, wherein the same or similar numbers are used to represent the same or similar components, and the description of the same technical contents is omitted.

With reference to FIG. 8, an electronic glasses 1 provided in this embodiment may be a smart glasses for vision correction. In some embodiments, the electronic glasses 1 may be configured to correct nearsightedness, farsightedness, presbyopia, astigmatism, or other visual impairment issues. The electronic glasses 1 has a structure of two frames 1R, two temples 1T, and a bridge 1N, where the corresponding frames 1R are connected to the corresponding temples 1T, and the bridge 1N is connected to the two frames 1R. In addition, in the present embodiment, the electronic glasses 1 may include the electronic device 10 (for example, one of the electronic devices 10a to 10g in the above embodiments), a circuit module 20, and a signal transmission element 30. The electronic device 10 is disposed on the frames 1R of the electronic glasses 1 and has an electrically tunable focusing function. The detailed description of the electronic device 10 can be referred to the above embodiments, and will be omitted herein. The circuit module 20 is disposed in the temples 1T of the electronic glasses 1 and is electrically connected to the electronic device 10. In some embodiments, the circuit module 20 may include a power supply unit (not shown), a touch sensor (not shown), a circuit board (not shown), and other corresponding elements to provide power to the electronic device 10 and/or to drive the electronic device 10, but the disclosure is not limited thereto. The signal transmission element 30 may be disposed in the frames 1R, the temples 1T, and the bridge 1N of the electronic glasses 1 and may serve to electrically connect the circuit module 20 to the electronic device 10.

In summary, in some embodiments of the electronic device, the protrusions of the transparent conductive layer extend to the side of the substrate, so that the conductive material disposed on the side of the substrate can be electrically connected to the protrusions of the transparent conductive layer. Therefore, the circuit module can be electrically connected to the electronic device through the protrusions and the conductive material, so the area of the outer lead bonding could be reduced, thereby reducing the size of the electronic device. Furthermore, when the motherboard is cut to form the panel of the electronic device, the possibility of breakage due to the protrusion of the outer lead bonding can be reduced, thereby improving the yield of the electronic device.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic device, including:
a first panel, including:
a first substrate, has a side;
a medium layer, disposed on the first substrate;
a first transparent conductive layer, disposed between the first substrate and the medium layer; and
a second transparent conductive layer, disposed between the first transparent conductive layer and the medium layer, wherein the first transparent conductive layer and the second transparent conductive layer extend to the side of the first substrate;
a first conductive material, disposed on the side of the first substrate and is electrically connected to the first transparent conductive layer; and
a second conductive material, disposed on the side of the first substrate and is electrically connected to the second transparent conductive layer.

2. The electronic device according to claim 1, wherein the first panel further includes:
a second substrate, opposite to the first substrate;
a third transparent conductive layer, disposed between the second substrate and the medium layer, wherein the third transparent conductive layer extends to a side of the second substrate; and
a third conductive material, disposed on the side of the second substrate and is electrically connected to the third transparent conductive layer.

3. The electronic device according to claim 2, wherein the first conductive material and the second conductive material are located between the first substrate and the second substrate.

4. The electronic device according to claim 2, wherein the second substrate includes a through hole, and the first transparent conductive layer is electrically connected to the first conductive material through the through hole.

5. The electronic device according to claim 4, wherein the through hole extends to the side of the second substrate.

6. The electronic device according to claim 4, wherein the through hole is filled with a transparent conductive material.

7. The electronic device according to claim 1, wherein the first transparent conductive layer includes a first protrusion, and the first protrusion extends to the side of the first substrate.

8. The electronic device according to claim 7, wherein the second transparent conductive layer includes a second protrusion, the second protrusion extends to the side of the first substrate, and the second protrusion does not overlap with the first protrusion.

9. The electronic device according to claim 8, wherein the second protrusion extends beyond the side of the first substrate.

10. The electronic device according to claim 1, further includes:
a second panel, adhered to the first panel through an adhesive layer.

11. The electronic device according to claim 1, wherein the first conductive material and the second conductive material contact the side of the first substrate.

12. The electronic device according to claim 2, further includes:
a sealant, disposed between the first substrate and the second substrate, and located around the medium layer.

13. The electronic device according to claim 1, wherein the first conductive material includes silver paste.

14. The electronic device according to claim 2, wherein the third transparent conductive layer includes a third protrusion, and the third protrusion extends to the side of the first substrate.

15. The electronic device according to claim 14, wherein the first transparent conductive layer includes a first protrusion, the second transparent conductive layer includes a second protrusion, and the first protrusion and the second protrusion extend to the side of the first substrate.

16. The electronic device according to claim 15, wherein the third protrusion does not overlap with the second protrusion and the first protrusion.

17. The electronic device according to claim 1, further includes:
a high resistance film, disposed on the second transparent conductive layer.

18. The electronic device according to claim 1, wherein the first conductive material contacts the side of the first substrate.

19. The electronic device according to claim 1, wherein a side of the first conductive material away from the medium layer is aligned with the side of the first substrate.

20. The electronic device according to claim 1, wherein the first panel is a panel with an irregular shape.
